(19) United States
(12) Patent Application Publication
(10) Pub. No.: US 2010/0217755 A1
(43) Pub. Date: Aug. 26, 2010

(54) CLASSIFYING A SET OF CONTENT ITEMS

(75) Inventor: Fabio Vignoli, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/680,593

(22) PCT Filed: Sep. 30, 2008
(86) PCT No.: PCT/IB08/53978

§ 371 Date: Mar. 29, 2010

(30) Foreign Application Priority Data
Oct. 4, 2007 (EP) 07117908.9

(51) Int. Cl. G06F 17/30

(52) U.S. Cl. 707/706; 707/723; 707/E17.108

(57) ABSTRACT

A method of classifying a set of content items, each content item including at least one signal (11) for rendering in perceptible form on a presentation system (1,2) of content items, includes obtaining an at least one-dimensional feature vector for each content item comprised in the set, at least one co-ordinate of the feature vector comprising a parameter value characterizing the content item. The method also includes providing at least one query to a system (14-17) configured to collect information descriptive of content items, each query including at least one of data identifying a content item of the set and data identifying an attribute common to the content items in the set, using results of each provided query to determine a sub-set of the set of content items, and classifying at least one content item in the set according to a measure of similarity between its feature vector and feature vectors obtained for content items in the sub-set.

### FIELD OF THE INVENTION

The invention relates to a method of classifying a set of content items, each content item including at least one signal for rendering in perceptible form on a presentation system of content items, which method includes obtaining an at least one-dimensional feature vector for each content item comprised in the set, at least one co-ordinate of the feature vector comprising a parameter value characterizing the content item.

The invention also relates to a system for classifying a set of content items, each content item including at least one signal for rendering in perceptible form on a presentation system of content items, which system is configured to obtain an at least one-dimensional feature vector for each content item comprised in the set, at least one co-ordinate of the feature vector comprising a parameter value characterizing the content item.

The invention also relates to a media player.

The invention also relates to a computer program product.

### BACKGROUND OF THE INVENTION

WO 2005/071569 discloses a system that includes a user interface that is coupled to an artist similarity module. A user identifies an artist via the interface, and the similarity module presents a list of similar artists found in a source of content material. The user initiates a one-click generation of a playlist when he/she is satisfied with the list of similar artists. At this point, a controller initiates an iterative artist-song selection process, via an artist selector and song selector. The song selection process is facilitated by a cluster module that is configured to pre-process songs from the source to identify clusters of similar songs within the source. Each item in a collection is associated with a corresponding point in an N-dimensional space. In a collection of songs, the attributes of each song, such as its genre, style, beat, strength and so on, determine its corresponding point in the N-dimensional space. The N-dimensional space is partitioned into clusters, based on the distribution of items in the N-dimensional space, and the “centre of gravity” of each cluster is determined. Each item is a member of the cluster of which the centre of gravity is closest to the item. If the user selects a low song-diversity level, the song selector selects from the most predominant cluster indicated by the cluster-histogram of this artist.

A problem of the known system is that it is not able automatically to select songs typifying an artist characterized by having a wide range of styles. Thus, it is not always good at classifying the entire set of songs by one artist into songs typical of the artist and those not representative of the artist's work.

### SUMMARY OF THE INVENTION

It is an object of the invention to provide a method, system, media player and computer program of the types mentioned in the opening paragraphs that are suitable for automatically classifying all content items in the set into those representative of a common characteristic of the content items in the set.

This object is achieved by the method according to the invention, which includes providing at least one query to a system configured to collect information descriptive of content items, each query including at least one of data identifying a content item of the set and data identifying an attribute common to the content items in the set,

using results of each provided query to determine a sub-set of the set of content items, and

classifying at least one content item in the set according to a measure of similarity between its feature vector and feature vectors obtained for content items in the sub-set.

The measure of similarity between the feature vector of the content item to be classified and feature vectors obtained for content items in the sub-set may be determined by determining the similarity between the feature vector of the content item to be classified and a feature vector derived from the feature vectors obtained for content items in the sub-set, such as an average or median feature vector. Also, the sub-set may contain only one content item.

By providing at least one query to a system configured to collect information descriptive of content items, each query including at least one of data identifying a content item of the set and data identifying an attribute common to the content items in the set, and by using the results of the provided queries to determine a sub-set of the set of content items, it is possible to obtain knowledge of a sub-set of content items that exemplify a common characteristic of the content items, e.g. the artist who produced them. Classifying at least one content item in the set according to a measure of similarity between its feature vector and feature vectors obtained for content items in the sub-set ensures that it is possible to partition the entire set of content items into those typical of the common characteristic of the content items, even if the system collecting information descriptive of content items does not hold information on each and every one of the content items in the set. An additional advantage is the potential for making efficient use of a system configured to collect information descriptive of content items that is external to the system arranged to carry out the method, since it is not necessary to send such an external system as many queries as there are content items in the set.

An embodiment of the method includes determining the sub-set of content items based on one of:

counts of how many messages identifying certain content items have been received over a certain time period by the system configured to collect information, and

counts of how many times information identifying certain content items appears in data provided to a data repository.

Counts of how many messages identifying certain content items have been received by the system configured to collect information over a certain time period are an indication of the relative familiarity of users with the content items. The same is true for counts of how many times information identifying certain content items appears in data provided to a data repository. The counts are a quantitative measure on which a criterion for selection of content items for inclusion in the sub-set can be based. Typical content items are likely to include those referred to most often.

In a variant, the data repository includes a network of servers arranged to provide access to files including text data.

Thus, the counts of how many times information identifying certain content items appears in files including text data are used to select content items for the sub-set. These are the content items that have generated most interest among the authors of the text data. They are most likely to be content items that stand out in terms of their perceptible characteristics.

In a variant, the system configured to collect information includes at least one search engine for returning links to files including text data corresponding to text data included in a query submitted to the system configured to collect information.

It is thus possible to obtain counts based on a large volume of text data without having to analyze the text data at the time the query is made.

In an embodiment, the method is carried out in one of a plurality of systems configured to carry out the method and to communicate with the system configured to collect information over a link through a telecommunications network.

An effect is that descriptive data pertaining to content items is collated and used in an efficient manner. A single system can collate a large amount of information, which need not be replicated at the systems arranged to carry out the method. These systems can classify all content items in a set stored locally.

In an embodiment, the query to the system configured to collect information includes data representative of an attribute common to the content items in the set, and the query is submitted to a system configured to collect information identifying content items in association with data identifying attributes of content items.

It is thus possible to obtain information descriptive of content items by submitting fewer queries and analyzing the results for the presence of identifications of content items in the set.

An embodiment includes obtaining data representative of the attribute from metadata stored with links to the content items in the set.

This reduces the amount of human intervention required to implement the method.

An embodiment of the method includes clustering a set of feature vectors, which set includes at least one of:

a set of feature vectors obtained for content items in the sub-set and

a set of feature vectors obtained for content items to be classified, wherein determining the measure of similarity to a feature vector includes determining a distance in feature space to a cluster including the feature vector.

It is thus possible to classify the content items whilst carrying out relatively few distance measurements.

An embodiment includes storing a set of metadata in association with each of the content items and the attribute common to the set of content items, which metadata includes a value of an attribute for indicating whether the feature vector of the content item has been classified as similar to those obtained for content items in the sub-set.

An effect is to allow use of the classification results in the construction of playlists in response to user commands. Content items typifying the attribute common to the set of content items, or conversely content items that are unusual, can be selected for inclusion in the playlists.

According to another aspect of the invention, there is provided a system for classifying a set of content items, each content item including at least one signal for rendering in perceptible form on a presentation system of content items, which system is configured:

to obtain an at least one-dimensional feature vector for each content item comprised in the set, at least one co-ordinate of the feature vector comprising a parameter value characterizing the content item,

to provide at least one query to a system configured to collect information descriptive of content items, each query including at least one of data identifying a content item of the set and data identifying an attribute common to the content items in the set,

to use results of each provided query to determine a sub-set of the set of content items, and

to classify at least one content item in the set according to a measure of similarity between its feature vector and feature vectors obtained for content items in the sub-set.

In an embodiment, the system is configured to carry out a method according to the invention.

According to another aspect, the media player according to the invention comprises a device for storing content items, a system for rendering signals included in the content items in perceptible form and a network interface for communication with an external system configured to collect information descriptive of content items, and further comprises a system according to the invention.

The media player is capable of classifying a locally stored set of content items having an attribute, such as the artist, in common according to whether they are typical of the artist or not. This is possible even if the artist is eclectic, and without the use of a local knowledgebase or human intervention.

According to another aspect, the computer program according to the invention includes a set of instructions capable, when incorporated in a machine-readable medium, of causing a system having information processing capabilities to perform a method according to the invention.

### BRIEF DESCRIPTION OF THE DRAWINGS

The invention will be explained in further detail with reference to the accompanying drawings, in which:

FIG. 1 is a schematic illustration of a system for implementing a method of classifying a set of content items;

FIG. 2 is a diagram schematically illustrating a class of content items;

FIG. 3 is a flow chart outlining a first embodiment of such a method; and

FIG. 4 is a flow chart outlining a second embodiment of such a method.

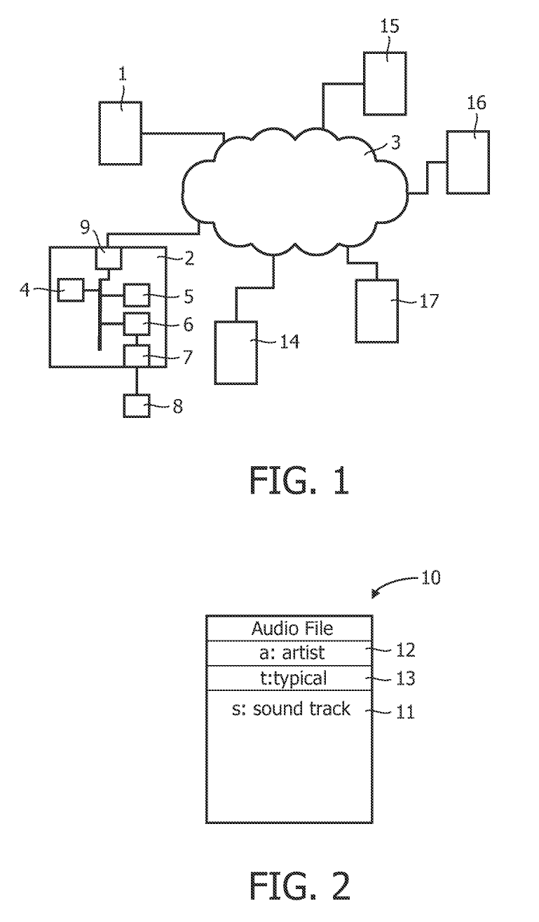

### DETAILED DESCRIPTION

A personal computer 1 and portable media player device 2 are connected to a network 3, preferably a Wide-Area Network such as the Internet. The personal computer 1 and portable media player device 2 both comprise examples of media players comprising a device for accessing locally stored content items. The device for accessing locally stored content items may include a hard disk drive, an interface to a portable memory device, e.g. a portable hard disk or solid-state memory device, etc.

As an example, the portable media player 2 comprises a data processing unit 4, a hard disk drive 5 for storing software including instructions to be executed by the data processing unit 4, as well as data files representing content items. The portable media player 2 is provided with a digital signal processor 6, digital-to-analogue converter 7 and earphones 8 for rendering digital audio or video into perceptible form. It also includes a network interface 9.

The content items may comprise sound, video or image files, each containing a signal for rendering in perceptible form by the media player. In the following, music files will be used as an example. Referring to FIG. 2, a class 10 of audio files includes digital data 11 encoding one or more audio signals, as well as metadata including values of attributes describing the content items. Illustrated are a tag 12 identifying the artist and a tag 13 for indicating whether the soundtrack is typical of the artist. In other embodiments, the files may include data pointing to metadata stored separately.

In FIG. 2, only a very limited amount of metadata is shown. Typically, the metadata will include the music's title, the performing artist, the genre of music, etc. It may include data representative of a feature vector, of which co-ordinates comprise parameter values characterizing the content item. In general, metadata comprises all types of descriptive data, whereas a feature vector in the present context includes parameter values, i.e. numerical values or elements of an ordered set on which a distance measure can be defined. In particular, at least some of the parameter values may be obtainable by carrying out a pre-determined analysis of the signal for rendering in perceptible form comprised in the content item. For an audio signal, examples of feature vector co-ordinates include loudness, bass, pitch, brightness, bandwidth and Mel-frequency cepstral coefficients. Other parameter values may include human-generated descriptive information, such as the year of release, etc. Some of the metadata can be obtained by submitting a query to an on-line database for storing metadata relating to content items. An example appropriate to audio files is a database made available over the Internet by Gracenote.

A music portal server 14 is arranged to make audio files available for download, and to collate information descriptive of the audio files made available for download, such as user ratings and frequency of download.

First and second web servers 15,16 are representative of a plurality of a much larger group of servers storing files including text data relating to artists and their works. An information retrieval server 17 comprises a web search engine for finding web pages and/or documents comprising text information matching search criteria specified in a query submitted to the server 17.

The personal computer 1 and portable media player 2 are programmed to classify sets of music files sharing an attribute value as typical of that attribute value or less representative of that attribute value. In the following, the example of the attribute “artist” will be used, but the concept can be extended to other attributes, such as genre or year of recording.

It is assumed that at least the songs identified most often in connection with an artist in information descriptive of songs are typical of that particular artist. It may happen that there are other songs that are very similar to those typical songs, but not identified as often. In order to find those, a two-stage process is carried out. First, a sub-set of the songs by a particular artist is identified using the descriptive data. These are classified as representative of the artist. Then, the remaining songs are classified as representative or not representative according to the similarity between the feature vector comprising parameter values characterizing the song to be classified and the feature vectors comprising parameter values characterizing the songs in the sub-set.

The first stage of the process is carried out with the aid of a system configured to collect information descriptive of the songs that is external to the personal computer 1 and the portable media player 2. The second stage of the process is carried out by the personal computer 11 or the portable media player 2 on the set of music files to which it has access. Using an external system to which other music players have access allows a large repository of descriptive data to be shared efficiently among the music players. The repository can be very large when provided in the form of a network of servers arranged to provide access to files including the descriptive data, such as the web servers 15,16.

In one embodiment (not illustrated in detail), the personal computer 1 or portable media player 2 submits a query to the music portal 14 for download statistics relating to the artist. In response, the music portal 14 returns a count of how many messages embodying download requests have been received by it over a certain time period for each song by that artist. The results of this query can be used to select a sub-set of songs, e.g. those with the highest count or all those with a count higher than a certain threshold value. Alternatively, the music portal 14 may receive a plurality of queries, each including an indication of one song to be classified, and it may return information representative of the counts in individual response messages over the network 3.

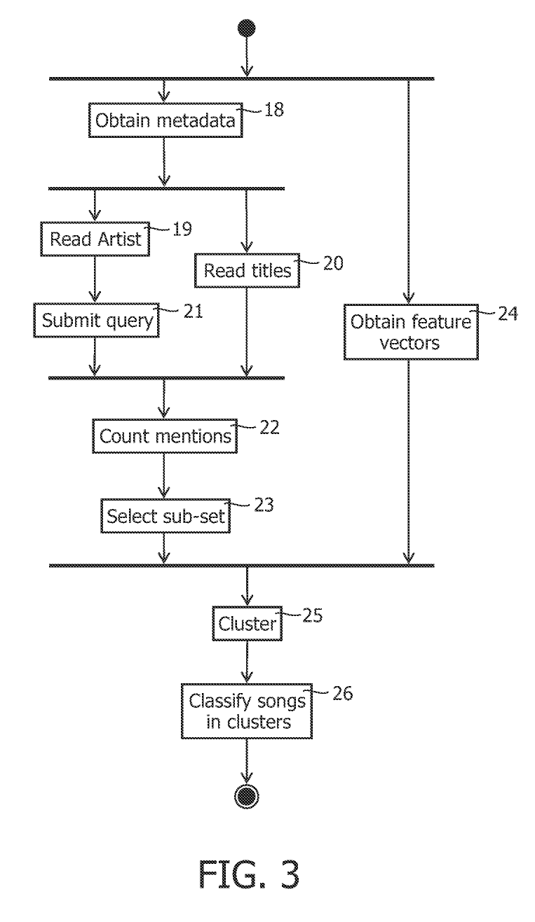

FIG. 3 illustrates a different embodiment of a method of classifying a set of audio files. The illustrated steps are carried out by the personal computer 1 or portable media player 2. They may also be carried out by a system associated with the music portal 14, if used to tag audio files available for download. Given a collection of audio files, metadata relating to those audio files is obtained (step 18). The name of the artist is obtained (step 19) and the titles of all the available songs by that artist are obtained (step 20). The name of the artist is used to formulate and send (step 21) a query to the server 17 hosting the web search engine. For each of the titles, the number of mentions in the search results are counted (step 22). Next (step 23), a sub-set of all songs by the artist is selected, corresponding to the songs of which the titles are most frequently mentioned on the Internet.

Feature vectors are also obtained for the songs by the artist of interest (step 24). This step 24 may involve carrying out a pre-determined analysis of the audio signal, or it may involve retrieving the results of such an analysis. It may also involve transforming descriptive data into quantitative data.

The feature vectors characterizing the songs in the sub-set determined in the preceding step 23 are clustered using a data clustering algorithm, as are the remaining songs of the artist (the songs yet to be classified as typical or atypical). Examples of data clustering algorithms are known, and will be carried out generally using distance in feature space between feature vectors. A hierarchical or partitional clustering algorithm may be used.

Subsequently, the songs in the clusters are classified (step 26) according to the distance between their cluster and the clusters of songs in the sub-set of most-mentioned songs by the artist. The value of the tag 13 in the metadata stored in association with those songs is then adjusted to indicate whether the feature vector of that song is distant or close to the feature vectors characterizing the sub-set of most-mentioned songs. The songs that are classified in this way are those songs in the set that are outside the sub-set.

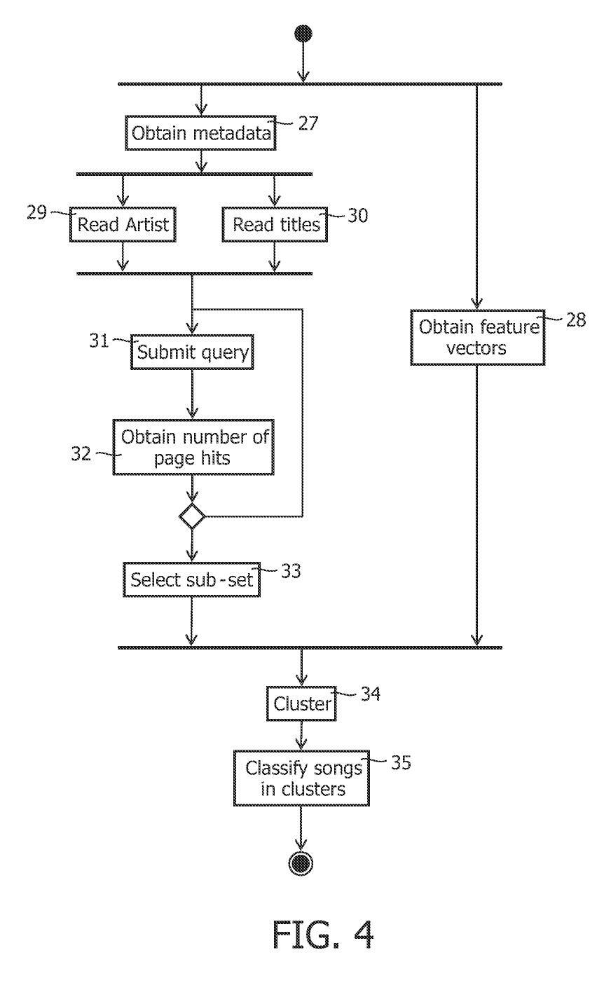

An alternative but similar method is illustrated in FIG. 4. It includes steps for obtaining metadata (step 27) and for obtaining feature vectors (step 28), corresponding to the steps 18,24 in the embodiment of FIG. 3. Similarly, the name of the artist is obtained (step 29), and the titles of all the songs by that artist in the set of songs to be classified are obtained (step 30). The embodiment of FIG. 4 differs from that of FIG. 3 in that it is more easily executed by a data processing system of limited capacity. A separate query including the song title is formulated and submitted (step 31) to the web search engine for each song. In an alternative embodiment, this may be done for a random sample of songs. Then, a count of the number of page hits is obtained from the web search engine for each song (step 32). The number of page hits is used to establish a sub-set of the most-mentioned songs (step 33).

Subsequently, steps 34,35, similar to steps 25,26, are carried out to classify the songs outside the sub-set of most-mentioned songs. Even if all song titles are submitted to the web search engine, this embodiment has the effect of correctly classifying songs that are typical of the artist, but not widely referred to on web-sites.

The tag 13 that is given a value as a result of the classification into typical and atypical songs allows the portable media player 2 to generate playlists based on requests for songs by a particular artist. The result is more likely to correspond to the request, in the sense that the playlist is likely to contain songs that are commonly regarded as typical of that artist and/or songs that are very similar in terms of their characteristics and are thus likely to be perceived as typical of that artist even if they are not well-known.

It should be noted that the embodiments described above illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

In variations of the described embodiments, where the content items include a signal representing a video sequence or a still image, contrast, brightness, relative strength of color components and the frequency of scene changes could be quantified and included as parameters defining the feature vector. In the illustrated methods, the steps 25,34 of clustering feature vectors are optional. It is also possible to classify content items according to the sum total of the distance of their feature vector to the feature vectors of each of the content items in the sub-set of most-mentioned content items, for example.

‘Means’, as will be apparent to a person skilled in the art, are meant to include any hardware (such as separate or integrated circuits or electronic elements) or software (such as programs or parts of programs) which perform in operation or are designed to perform a specified function, be it individually or in conjunction with other functions, be it in isolation or in co-operation with other elements. ‘Computer program’ is to be understood to mean any software product stored on a computer-readable medium, such as an optical disk, downloadable via a network, such as the Internet, or marketable in any other manner.

1. Method of classifying a set of content items, each content item including at least one signal (11) for rendering in perceptible form on a presentation system (1,2) of content items, which method includes:
obtaining an at least one-dimensional feature vector for each content item comprised in the set, at least one co-ordinate of the feature vector comprising a parameter value characterizing the content item,
providing at least one query to a system (14-17) configured to collect information descriptive of content items, each query including at least one of data identifying a content item of the set and data identifying an attribute common to the content items in the set,
using results of each provided query to determine a sub-set of the set of content items, and
classifying at least one content item in the set according to a measure of similarity between its feature vector and feature vectors obtained for content items in the sub-set.

2. Method according to claim 1, including determining the sub-set of content items based on one of:
counts of how many messages identifying certain content items have been received over a certain time period by the system (14-17) configured to collect information, and
counts of how many times information identifying certain content items appears in data provided to a data repository (15,16).

3. Method according to claim 2, wherein the data repository includes a network of servers (15,16) arranged to provide access to files including text data.

4. Method according to claim 2, wherein the system configured to collect information (15-17) includes at least one search engine for returning links to files including text data corresponding to text data included in a query submitted to the system (15-17) configured to collect information.

5. Method according to claim 1, wherein the method is carried out in one of a plurality of systems (1,2) configured to carry out the method and to communicate with the system (14-17) configured to collect information over a link through a telecommunications network (3).

6. Method according to claim 1, wherein the query to the system (14-17) configured to collect information includes data representative of an attribute common to the content items in the set, and wherein the query is submitted to a system configured to collect information identifying content items in association with data identifying attributes of content items.

7. Method according to claim 6, including obtaining data representative of the attribute from metadata (12) stored with links to the content items in the set.

8. Method according to claim 1, including clustering a set of feature vectors, which set includes at least one of:
a set of feature vectors obtained for content items in the sub-set and
a set of feature vectors obtained for content items to be classified,
wherein determining the measure of similarity to a feature vector includes determining a distance in feature space to a cluster including the feature vector.

9. Method according to claim 1, including storing a set of metadata (13) in association with each of the content items and the attribute common to the set of content items, which metadata includes a value of an attribute for indicating whether the feature vector of the content item has been classified as similar to the feature vectors obtained for content items in the sub-set.

10. System for classifying a set of content items, each content item including at least one signal (11) for rendering in perceptible form on a presentation system (1,2) of content items, which system is configured:
to obtain an at least one-dimensional feature vector for each content item comprised in the set, at least one co-ordinate of the feature vector comprising a parameter value characterizing the content item,
to provide at least one query to a system (14-17) configured to collect information descriptive of content items, each query including at least one of data identifying a content item of the set and data identifying an attribute common to the content items in the set,
to use results of each provided query to determine a sub-set of the set of content items, and
to classify at least one content item in the set according to a measure of similarity between its feature vector and feature vectors obtained for content items in the sub-set.

11. System according to claim 10, configured to carry out a method according to claim 1.

12. Media player comprising a device (5) for storing content items, a system (6-8) for rendering signals included in the content items in perceptible form and, a network interface (9) for communication with an external system (14-17) configured to collect information descriptive of content items, further comprising a system according to claim 10.

13. Computer program including a set of instructions capable, when incorporated in a machine-readable medium (5), of causing a system (1,2) having information processing capabilities to perform a method according to claim 1.
